(19) United States
(12) Patent Application Publication
(10) Pub. No.: US 2020/0120764 A1
(43) Pub. Date: Apr. 16, 2020

(54) METHOD OF ELECTRO-HYDRODYNAMIC PROCESSING OF HYDROCARBON SUBSTANCES AND THE FACILITIES FOR ITS IMPLEMENTATION

(71) Applicants: Alexander Prutkovsky, New York, NY (US); Ilia Novikov, Rybinsk (RU)

(72) Inventors: Alexander Prutkovsky, New York, NY (US); Ilia Novikov, Rybinsk (RU)

(21) Appl. No.: 16/596,310

(22) Filed: Oct. 8, 2019

Related U.S. Application Data
(60) Provisional application No. 62/744,064, filed on Oct. 10, 2018.

(51) Int. Cl. H05B 6/50; C10G 9/24; D01D 5/00

(52) U.S. Cl. CPC H05B 6/50; H05B 2214/03; D01D 5/0069; C10G 9/24

(57) ABSTRACT

The method of electro-chemical processing of hydrocarbon substances, which includes the stage of conversion of those substances in a mixture with water or electrolyte solution by means of its processing with variable electric current. An electro-chemical processing is carried out by a two-stage treatment, comprising a primary electro-hydrodynamic processing by means of an exposure to high voltage, short-pulse electric current discharges of variable frequency, and also comprising the main electro-hydrodynamic processing, carried out in strongly whirling counterflows of the mixture, in the field with a high radial pressure gradient, by exposing the substance to an intensive cavitation, highly developed turbulence, acoustic pressure vibrations, high-frequency alternating electromagnetic field and secondary short-circuited electric currents induced in the conductive mixture, along with a simultaneous separation of the substances formed. The device for electro-hydrodynamic processing of hydrocarbon substances, containing a block for primary electro-hydrodynamic mixture processing is also described and claimed.

### FIELD OF THE INVENTION

The invention relates to the electro-hydrodynamic technologies of processing hydrocarbon-containing substances with obtaining high molecular hydrocarbons and other liquid derivative products.

### DESCRIPTION

### Summary of the Present Invention

The invention relates to the electro-hydrodynamic technologies of processing hydrocarbon-containing substances with obtaining high molecular hydrocarbons and other liquid derivative products. As the substances for the processing there can be used coal, coal dust, wood and agricultural waste, as well as prepared for processing household and industrial waste, including oil processing waste (oil slimes), the waste of disposal facilities, of poultry farms, pig-breeding complexes, etc. The method includes the stage of the substances' conversion and synthesis in a mixture with water or electrolyte and is carried out by a two-stage treatment, comprising a primary electro-hydrodynamic processing by means of an exposure to high voltage, short-pulse discharges, and the main electro-hydrodynamic processing, carried out in strongly whirling counterflows, by means of an exposure of the mixture of the substance with fluid to an intensive cavitation, highly developed turbulence, acoustic pressure vibrations, high-frequency alternating electromagnetic field and electric currents, along with a simultaneous separation of the substances formed. The device, that implements the proposed method, contains blocks of primary electro-hydrodynamic mixture processing, a tangential nozzle swirling device, a vortex chamber with an inside block of coaxial tubular conductors and its cylindrical outer surface surrounded by a block of electrical windings, which generate high frequency alternating electromagnetic field in the vortex chamber.

The object of the invention is to increase the efficiency of the method as well as of the device for processing hydrocarbon substances by increasing productivity, improving environmental and economic performance as well as by expanding the types of the substances to be processed.

The said object is achieved by the following: the processing method, which includes the stages of the substances' conversion and synthesis in a mixture with water or electrolyte, is carried out by a two-stage treatment, comprising a primary electro-hydrodynamic processing, by an exposure to high voltage, short-pulse electric current discharges of variable frequency, and also comprising the main electro-hydrodynamic processing, carried out in strongly whirling counterflows, in the field with a high radial pressure gradient, by exposing the substance to an intensive cavitation, highly developed turbulence, acoustic pressure vibrations, high-frequency alternating electromagnetic field and secondary short-circuited electric currents induced in the conductive mixture, along with a simultaneous separation of the substances formed. The device, that implements the proposed method, contains blocks of primary electro-hydrodynamic mixture processing, a tangential nozzle swirling device, a vortex chamber with an inside block of coaxial tubular conductors and its cylindrical outer surface surrounded by a block of electrical windings, which generate in the vortex chamber high frequency alternating electromagnetic field, wherein the vortex chamber is made of a dielectric material, the inner surface of which is coated with a catalytic agent.

### BRIEF DESCRIPTION OF THE DRAWINGS

FIG. 1 illustrates a longitudinal sectional view of the device of the present invention,

FIG. 2 illustrates a sectional view, taken on line A-A of the embodiment, illustrated on FIG. 1;

FIG. 3 illustrates a sectional view, taken on line B-B of the embodiment, illustrated on FIG. 1.

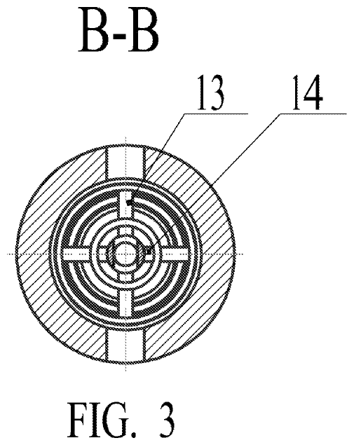

FIG. 4 is a flow chart, illustrating the steps of the method of the present invention.

### DETAILED DESCRIPTION OF THE PREFERRED EMBODIMENTS

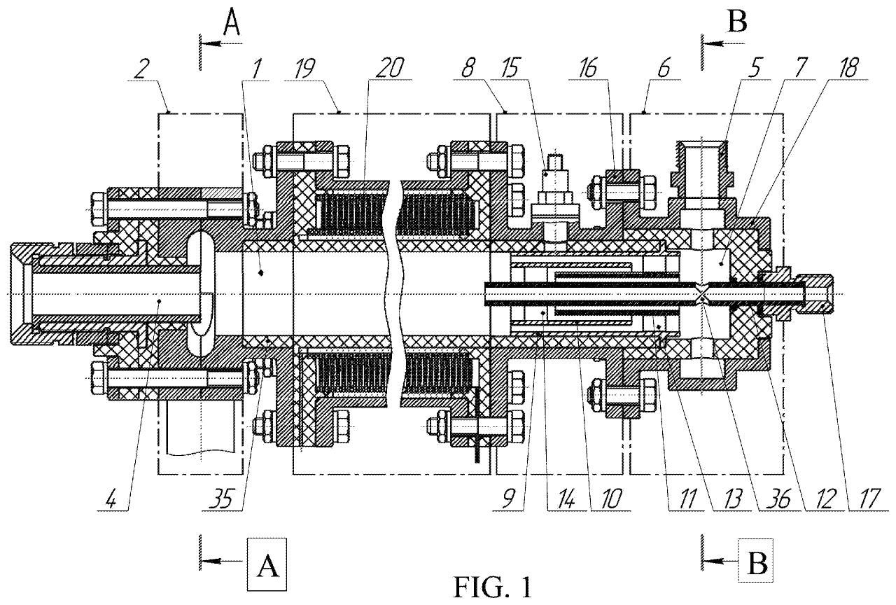

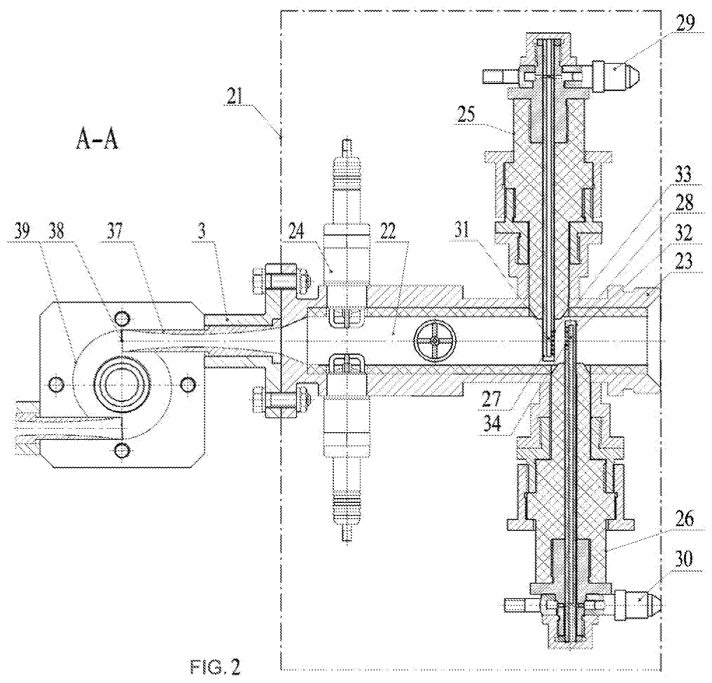

The device (FIG. 1) comprises: a vortex chamber 1, a tangential nozzle swirling device 2 (FIG. 2), with one or more tangential inlet fittings 3 (FIG. 2). In the plane of tangential nozzle swirling device 2 (FIG. 1), in alignment with vortex chamber 1, one outlet fitting 4 is mounted, and the other outlet fitting 5 is mounted at the opposite end of vortex chamber, at the outlet device's block 6, which is contained within cavity 7, which is interconnected to fitting 5.

Mounted at the opposite end of vortex chamber 2 (FIG. 1) there is a block of coaxial tubular conductors 8 designed as coaxial cylindrical shells 9, 10, 11 and 12 in alignment with the central axis of vortex chamber 1. Shells 9 and 11 (FIG. 1) are connected evenly along the circumference by four or more flat jumper straps 13, and shells 10 and 12 are connected evenly along the circumference by four or more flat jumper straps 14, wherein jumper straps 13 and 14 are mounted at different ends of shells 9, 11 and 10, 12 correspondingly. Outer shell 9 (FIG. 1) as well as shell 11, connected to it by a jumper strap 13, are connected with the current supply electrode 15, placed on a cylindrical wall 16 of block 8, and shell 10 as well as shell 12, connected to it by a jumper strap 14, are connected with the current supply electrode 17, placed on the end wall of the output device's block 6; electrodes 15 and 17 are connected with the external switching device which supplies alternating electric current to a block of coaxial tubular conductors.

In vortex chamber 1 (FIG. 2), between tangential nozzle swirling device 2 and block 8, block 19 is mounted, which contains windings of circumferentially wound conductors 20, which block is connected to the external switching device, generating high frequency alternating electromagnetic field in the vortex chamber, wherein the switching device is designed with a possibility of varying frequency and direction of the electric current supplied to the block of electrical windings.

One or more tangential inlet fittings 3 (FIG. 2) are connected in alignment with one or more primary blocks 21 of electro-hydrodynamic processing of mixture of water or electrolyte with a substance milled before electrochemical processing. Each of blocks 21 (FIG. 2) contains an axisymmetric chamber 22 with inlet fitting adapter 23, which contains one or more dischargers 24 connected to an external switching device, which generates, supplies and provides high voltage, short-pulse electric current discharges at dischargers.

The use of several dischargers 24 is determined by the necessity to reduce the electrical load on the electrodes and thereby to increase their life.

Dischargers 24 (FIG. 2) are placed both along the length and along the circumference of axisymmetric chamber 22, and their number depends on the device's productivity as well as on the type of the substance to be processed.

Chamber 22 may be equipped with two or more pairs of discharge devices 25 and 26 (FIG. 2), which contain electrodes 27 and 28, placed radially and in parallel and connected with an external switching device, which generates, supplies and provides high voltage, short-pulse electric current discharges between electrodes 27 and 28.

Discharge devices 25 and 26 (FIG. 2) at the inlet contain fitting adapters 31 and 32 correspondingly, that are connected to external sources of air or oxygen or hydrogen or methane-containing gas. The flow parts of fitting adapters 29 and 30 (FIG. 2) are connected to the flow parts located inside electrodes, 31 and 32 correspondingly, which, in their lateral surface, have calibrated openings 33 and 34 made along the radial forming surface towards each other.

Outlet fitting 4 (FIG. 1), placed at the inlet to vortex chamber 1, is connected to a cathode electrode, and outlet fitting 5, mounted at the opposite end of vortex chamber, is connected to the anode electrode of the external power source.

The inner casing 35 of vortex chamber 1 (FIG. 1) is made of a dielectric material and is coated with catalytic agents containing zinc, chromium, group VIII metals of the Periodic system of chemical elements and ZSM type zeolites with metal salts.

The inner surface of outlet fitting 4 (FIG. 1), placed at the inlet to vortex chamber 1, is coated with catalytic agents, containing carbides, nitrides, borides and oxides of group IV metals of the Periodic system of chemical elements.

Shell 12 (FIG. 1), which is connected with the current supply electrode 17 placed on the end wall 18 of block 6 of the output device, contains openings 36, interconnected with the inner volume 36 of block 6.

Nozzles 37, designed as a de Laval nozzle, are inserted in tangential inlet fittings 3 (FIG. 2) to form the flow part of tangential nozzle swirling device 2, outlet parts 38 of which are tangentially interconnected with ring channels 39, that form the inner surface of tangential nozzle swirling device 2, shaped in accordance with the spiral of Archimedes.

The proposed device operates in the following way. The mixture, prepared for processing, is fed from an external source to a block or several blocks of primary electrodynamic mixture processing 21 (FIG. 2); through fitting adapter 23 it enters chamber 22, wherein it forms an axisymmetric sustained flow.

At dischargers 24 (FIG. 2) the high voltage, short-pulse electric current discharges of variable frequencies, generated by external switching device, are carried out. Discharges are carried out by dischargers 24 (FIG. 2), placed both along the length and along the circumference of axisymmetric chamber 9, as well as jointly along the length and along the circumference, the number of which depends on the device's productivity and on the type of the substance to be processed.

In case the chamber is provided with two or more pairs of discharge devices 25 and 26 (FIG. 2), high voltage, short-pulse electric current discharges of variable frequency, generated by external switching device, are carried out in them. Discharges are formed between electrodes 27 and 28 (FIG. 2), placed radially and in parallel.

Depending on the substance to be processed, either air or hydrogen or methane-containing gas or other gas is fed into fitting adapters 29 and 30 (FIG. 2), that passes inside electrodes through channels 31 and 32 correspondingly, and through openings 33 and 34 it goes in the form of axial streams, directed towards each other, into an axial clearance, forming in it a gas saturated area, where discharges are formed.

The use of short-pulse electrical discharges results in a strong mechanical compression, generation of powerful ultrasound, x-ray, ultra-violet and infrared radiations in the areas of discharge, which induce thermal and shock effects, electromagnetic fields, ionization, dissociative, cavitation as well as physical and chemical effects.

Supply of a gas fraction to the discharge area intensifies cavitation, initiates exothermic reactions of higher hydrocarbons' synthesis, reduces the required operating discharge voltage.

In chamber 22 (FIG. 2) a flow, which includes a gas fraction, dissociated and ionized components, is formed.

Thus, the design, which implements the proposed method, leads to an increase of productivity for the substance to be processed, improvement of the environmental performance due to the lack of environmental emissions, enhancement of economic performance by increasing the liquid derivative products, as well as to an expansion of the types of the substances to be processed. All this facilitates an increase of the efficiency of the proposed method of implementation of the operational process of hydrocarbon substances' processing as well as of the design of the device for its implementation.

The accelerated flow processed in chamber 22 of blocks 21 (FIG. 2) is fed into nozzles 37 designed as de Laval nozzles, placed in inlet fittings 3 of tangential nozzle swirling device 2 (FIG. 1); it is accelerated and withdrawn through outlet openings 38, which tangentially interface with the ring channels' 39 (FIG. 2) surface, profiled in accordance with the spiral of Archimedes.

In nozzles 37 (FIG. 2) a high-speed three-phase flow, which includes cavitation, dissociative and ionized components, is formed. As the flow moves, the cavitation bubbles' quantity in nozzles 37 increases with the increase of the flow velocity.

Thus, the design, which realizes the proposed method of implementation of the operational process, leads to an increase of productivity for the substance to be processed as well as to enhancement of economic performance by reducing the energy load on the subsequent blocks. All this facilitates an increase of the efficiency of the proposed method of implementation of the operational process of hydrocarbon substances' processing as well as of the design of the device for its implementation.

The strongly whirling flow, formed in device 2 (FIG. 1), is fed into vortex chamber 1, wherein are formed strongly whirling internal and external flows, moving in a counterflow with the axial velocity components. External flow moves away from tangential nozzle swirling device 2, and internal flow, induced by it, moves in the opposite direction and exits from the device through outlet fitting 4. External flow moves over the vortex chamber's 4 internal surface, made of dielectric material and coated with a catalytic agent, and internal flow moves over the fitting's 4 internal surface, coated with a catalytic agent.

At the point of the internal and external flows' separation, shear axial velocities generate an intensive anisotropic turbulence, prevailing in the radial direction, in the field with a high radial pressure gradient.

Turbulent moles, moving in the radial direction, generate high frequency pressure fluctuations, intensify cavitation effects, lead to heating the flows, facilitate the formation of oxygen and hydrogen ions.

The radial pressure gradient in vortex chamber leads to a density separation of oxygen, hydrogen ions along with other flow elements. Hydrogen ions move into internal flow, and oxygen ions move into external flow, increasing the rate of exothermic chemical synthesis reactions.

The flows' rising temperature increases the water dissociation degree that obtains the properties of a solvent, reagent, catalytic agent, which, combined with catalytic agents on the inner surfaces of vortex chamber and of outlet nozzle, results in an increase of the rates and expansion of the types of exothermic chemical synthesis reactions.

Heating of the flow results in formation at the separation point of external and internal flows of a water-steam phase transfer, with steam condensation in external flow, which leads to its additional heating, growth of pressure, achieving the water boiling point, to the increase of the dissociation degree at the separation point, to creation of a static difference of electric field potentials. These effects facilitate the increase of the rates and expansion of the types of exothermic chemical synthesis reactions.

The increase of the rates of chemical synthesis reactions is facilitated by the use of catalytic agents. In external flow catalytic agents contain zinc, chromium, group VIII metals of the Periodic system of chemical elements and ZSM type zeolites with metal salts. At the outlet of internal flow, placed under an electric cathode potential, catalytic agents contain carbides, nitrides, borides and oxides of group IV metals of the Periodic system of chemical elements.

Thus, the vortex chamber design, which realizes the proposed method of implementation of the operational process, leads to an increase of productivity for the substance to be processed, to enhancement of economic performance as well as to an expansion of the types of the substances to be processed. All this facilitates an increase of the efficiency of the proposed method of implementation of the operational process of hydrocarbon substances' processing as well as of the design of the device for its implementation.

Strongly whirling external flow is moved to the opposite from swirling device end of vortex chamber 1 (FIG. 1), is fed into block 8, and is moved along coaxial channels between shells 9 and 10, 11 and 12, wherein the flow is additionally swirled by aligning radial velocity by means of jumper straps 13 and 14; then it is withdrawn into the inner volume 7 of block 6, from where one part of the flow is moved to outlet fitting 5, which contains an external flow control valve and is under an electric cathode potential, and the other part is fed through openings 36 into the channel inside shell 12, wherein one part of the flow is directed into internal flow of chamber 1 and the other part of the flow is withdrawn through hollow electrode 17.

Alternating electric current is fed from external switching device to electrodes 15 and 17 (FIG. 1). As the result, an electrolysis is carried out in the water flow containing hydrocarbon substance's dust, along with the implementation of the processes of heating, thermal dissociation and ionization of the flow, that are induced in an electrically conductive medium by secondary short-circuited electric currents.

Heating of water results in an increase of the dissociation degree. Water obtains the properties of a solvent, reagent, catalytic agent that facilitates an increase of the rate of exothermic synthesis reactions, which results in an increase of the substance processing productivity.

A medium, saturated with ionized hydrogen, is formed in inner volume 7 of block 6 (FIG. 1) with a simultaneous separation in it of the substances of different density along with their segregated withdrawal: more dense—through fitting 5, less dense and gaseous substances, including hydrogen—through an ring opening between shells 11 and 12, and through opening 36 in shell 12 they are fed into internal flow of vortex chamber, or through an opening in electrode 17 are withdrawn for further implementation, for example, for the use as a gaseous fraction fed into discharge devices 25 and 26. This results in an increase of types and quantity of liquid products, which provides the enhancement of economic performance.

The use of an electrolyte as a liquid component of the mixture to be processed expands the area of application of the method and the device according to the type of the substance to be processed, improves the environmental characteristics due to processing and disposal of hydrocarbon-containing industrial waste (for example, oil slimes). All this facilitates an increase of the efficiency of the proposed method of implementation of the operational process of hydrocarbon substances' processing as well as of the design of the device for its implementation.

In vortex chamber 1 (FIG. 1), at the section between tangential nozzle swirling device 2 and block 8, external and internal flows are fed into the effective area of block 19 for high frequency electromagnetic processing.

From external switching device to the coils of conductors 20 (FIG. 1) an electric current is supplied, which generates in the flows a high frequency alternating electromagnetic field of variable frequency and direction.

By changing frequency and direction of electric current, a high frequency alternating electromagnetic field is formed inside vortex chamber, which creates a broadband resonance amplification of its own frequencies in the flows, including the frequencies of the radial fluctuations of charged turbulent moles, dissociated and ionized molecules, vibrations of collapsed cavitation bubbles and others.

In vortex chamber there takes place an intensification of heating processes, heat-mass exchange processes, formation of active charged particles, increase of the rates of the chemical reactions of liquid and gaseous hydrocarbon products synthesis processes.

The proposed method is implemented as follows. It is prepared a fluid mixture, for example, water or electrolyte with a substance milled to dust, which is fed into one or more blocks for primary processing of mixture 21 (FIG. 2). An axisymmetric sustained flow of mixture is formed in chamber 22 (FIG. 2), inside which flow the primary electro-hydrodynamic processing of the mixture is carried out.

Within the flow there are provided high voltage, short-pulse electric current discharges of variable frequency, generated by external switching device.

The discharges are distributed both along the length and along the circumference of axisymmetric flow, as well as jointly along the length and along the circumference. The number of discharges depends on the device's productivity as well as on the type of the substances to be processed.

In addition to these discharges, high voltage, short-pulse electric current discharges of variable frequency, that are placed along the radius of axisymmetric flow, between a pair of or several pairs of electrodes 27 and 28 (FIG. 2) placed in parallel, are formed.

Depending on the substance to be processed, the area of parallel radial discharges is supplied with either air or hydrogen or methane-containing gas or other gas, which is formed as axial streams directed towards each other, and which is fed into an axial clearance, forming in it a gas saturated area, wherein discharges are carried out.

The use of short-pulse electrical discharges results in a strong mechanical compression, generation of powerful ultrasound, x-ray, ultra-violet and infrared radiations in the areas of discharge, which induce thermal and shock effects, electromagnetic fields, ionization, dissociative, cavitation as well as physical and chemical effects.

Supply of a gas fraction to the discharge area intensifies cavitation, initiates exothermic reactions of higher hydrocarbons' synthesis, reduces the required operating discharge voltage.

The formed axisymmetric mixture flow, which includes a gas fraction, dissociated and ionized components, is accelerated.

Thus, the implementation of primary electro-hydrodynamic mixture processing within the proposed method leads to an increase of productivity for the substance to be processed, improvement of environmental performance due to the lack of environmental emissions, enhancement of economic performance by increasing the liquid derivative products, as well as to an expansion of the types of the substances to be processed.

The formed axisymmetric mixture flow is fed into tangential nozzle swirling device 2 (FIG. 1), is accelerated along with the increase of cavitation bubbles' quantity, and is withdrawn in the form of a high-speed three-phase flow, which includes cavitation, dissociative and ionized components.

Thus, the formation, within the proposed method, of a strongly whirling high-speed three-phase flow, containing cavitation, dissociated and ionized components, results in a possibility of carrying out the main phase of the electro-hydrodynamic mixture processing in vortex chamber, where the implementation of the operational process facilitates an increase of the efficiency of the proposed method of hydrocarbon substances' processing.

The strongly whirling flow, formed in device 2 (FIG. 1), is fed into vortex chamber 1, wherein it forms strongly whirling internal and external flows, moving in a counterflow with the axial velocity components.

External flow is directed away from tangential nozzle swirling device 2 (FIG. 1), and internal flow, induced by it, is moved in the opposite direction and is withdrawn from the device through outlet fitting 4; in this case external flow is formed as moving over the vortex chamber's internal surface, made of dielectric material and coated with a catalytic agent, and internal flow moves over fitting's 4 internal surface, coated with a catalytic agent.

At the point of internal and external flows' separation, shear axial velocities generate an intensive anisotropic turbulence, prevailing in the radial direction, in the field with a high radial pressure gradient.

Turbulent moles, moving in the radial direction, generate high frequency pressure fluctuations, intensify cavitation effects, lead to heating the flows, facilitate the formation of oxygen and hydrogen ions.

The radial pressure gradient in vortex chamber leads to a density separation of oxygen, hydrogen ions along with other flow elements; in this case hydrogen ions move to internal flow, and oxygen ions move to external flow, causing exothermic chemical synthesis reactions.

The flows' rising temperature increases the water dissociation degree that obtains the properties of a solvent, reagent, catalytic agent, which, combined with catalytic agents on the inner surfaces of vortex chamber and of outlet nozzle, results in an increase of the rates and expansion of the types of exothermic chemical synthesis reactions.

Heating of the flow results in formation at the separation point of external and internal flows of a water-steam phase transfer, with steam condensation in external flow, which leads to its additional heating, growth of pressure, achieving the water boiling point, to an increase of the dissociation degree at the separation point, to creation of a static difference of electric field potentials. These effects facilitate the increase of the rates and expansion of the types of exothermic chemical synthesis reactions.

The increase of the rates of exothermic chemical synthesis reactions is facilitated by the use as catalytic agents in external flow such catalytic agents, that contain zinc, chromium, group VIII metals of the Periodic system of chemical elements and ZSM type zeolites with metal salts, and at the outlet of internal flow—catalytic agents containing carbides, nitrides, borides and oxides of group IV metals of the Periodic system of chemical elements.

Thus, the processes implemented in vortex chamber through the proposed method facilitates an increase of the efficiency of the proposed method of implementation of the operational process of hydrocarbon substances' processing as well as of the design of the device for its implementation.

External flow is moved to the opposite from the swirling device end of vortex chamber 1 (FIG. 1); it is fed into block 8, and is moved along coaxial channels between shells 9 and 10, 11 and 12. The flow is additionally swirled while it moves over jumper straps 13 and 14 and is withdrawn into inner volume 7 of block 6, from where one part of the flow is moved to outlet fitting 5 and the other part is fed through openings 36 into the channel inside shell 12, wherein one part of the flow is directed into internal flow of chamber 1 and the other part of the flow is withdrawn through hollow electrode 17.

Alternating electric current is fed from external switching device to electrodes 15 and 17 (FIG. 1). As the result, an electrolysis is carried out in the water flow containing hydrocarbon substance's dust, along with the implementation of the processes of heating, thermal dissociation and ionization of the flow, that are induced in an electrically conductive medium by secondary short-circuited electric currents.

Heating of water results in an increase of the dissociation degree. Water obtains the properties of a solvent, reagent, catalytic agent, which facilitates an increase of the rate of exothermic synthesis reactions, which results in an increase of the substance processing productivity.

In inner volume 7 of block 6 (FIG. 1) the separation of the substances of different densities along with their segregated withdrawals is carried out.

The more dense flow components are withdrawn through fitting 5 (FIG. 1) for their further processing. One part of the less dense and gaseous components, including hydrogen, is withdrawn through a ring opening between shells 11 and 12 into internal flow (FIG. 1). The other part is fed through opening 36 of shell 12 into internal flow of vortex chamber, and/or through an opening in electrode 17 is withdrawn to be used as a gaseous fraction fed into discharge devices 25 and 26 (FIG. 2).

The use of an electrolyte as a mixture's liquid component expands the area of application of the method according to the type of the substance to be processed, improves the environmental characteristics due to processing and disposal of hydrocarbon-containing industrial waste (for example, oil slimes).

All this facilitates an increase of the efficiency of implementing the operational process in the vortex chamber and, consequently, of the entire process as a whole.

The flows, formed in vortex chamber 1 (FIG. 1), are exposed to high frequency alternating electromagnetic field of variable frequency and direction, generated by electric current from external switching device, which is fed to the conductors' coils, that cover vortex chamber.

By changing frequency and direction of electric current, a high frequency alternating electromagnetic field is formed inside vortex chamber, which creates in the flows a broadband resonance amplification of its own frequencies, including the frequencies of the radial fluctuations of charged turbulent moles, dissociated and ionized molecules, vibrations of collapsed cavitation bubbles and others.

In vortex chamber there takes place an intensification of heating processes, heat-mass exchange processes, formation of active charged particles, increase of the rates of the chemical reactions of liquid and gaseous hydrocarbon products synthesis processes.

Implementation of the method of exposing the prepared flow to an electromagnetic effect in vortex chamber, with formation of broadband resonance amplification of its own frequencies, results in an intensification of physical and chemical processes, and thus in an increase of the efficiency of implementing the operational process of hydrocarbon substances' processing in vortex chamber and, consequently, of the entire process as a whole.

Electro-hydrodynamic treatment is being performed by way of complementary feeding thus processed mixture with argon from an external source.

Conducting such a treatment with a complementary introduction of argon intensifies the process of breaking down long molecules in worked-on hydrocarbons, for example finely crushed polyethylene, which in turn expands application field for the described method.

Implementation of the method, and its realization in the device, of exposing the prepared flow to an electromagnetic effect in vortex chamber, with formation of broadband resonance amplification of its own frequencies, results in an intensification of physical and chemical processes, and thus in an increase of the efficiency of implementing the operational process of hydrocarbon substances' processing in vortex chamber.

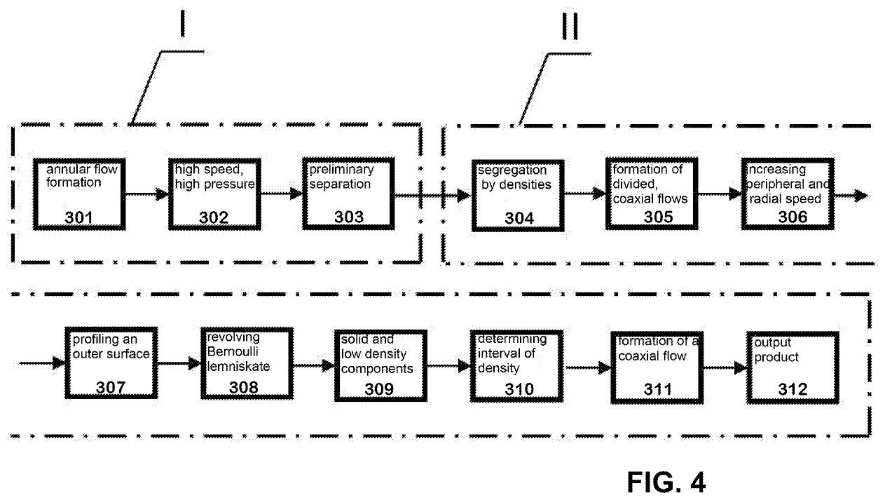

FIG. 4 is a Flow Chart, illustrating the steps of the method of the present invention.

Among the other details, the flow chart illustrates the following aspects of the invention:

I—Destruction Module (D-module)

II—Separation Module (S-module)

D-module realizes the following operations:

Preparing and feeding input product mixture for destruction;

Creating annular, axis streaming with an even distribution of mixture in its cross-section, flow.

Step 1 (Box 301) is forming an annular flow, which is surrounded by and interacts with a toroidal flow.

Step 2 (Box 302) is responsible for generating a high speed, high pressure water flow by way of creation of revolving with a high frequency within its formation plane, radial, accelerated water streams, which are in turn forming a flat, high frequency revolving, annular water flow for into the Step 3 (Box 303).

Function of S-module is a preliminary separation of suspended mixture limiting Step maximal dimensions of solid components:

Step 4 (Box 304) is dividing a suspended mixture based on densities of its components.

Step 5 (Box 305) is further separating a suspended mixture into components by way of formation of divided, coaxial flows.

Step 6 (Box 306) is responsible for increasing peripheral and radial components of the speed within the plane of circular flow formation.

Step 7 (Box 307) is for a compensation of lowering a radial gradient of pressure by way of profiling an outer surface of the external flow.

Step 8 (Box 308) is executing profiling by revolving Bernoulli lemniskate around a central axis of the flow and thus narrowing a flow passage from the initial point of an axisymmetric flow formation.

Step 9 (Box 309) is for concentrating solid components in a peripheral part of the external flow and those with a lower densities—in a paraxial field of the internal one.

Step 10 (Box 310) determines a beginning of formation of coaxial flows with a defined interval of density.

Step 11 (Box 311) is forming a coaxial flow at the input to generate flows with a wider density distribution as in a confluent flow.

Step 12 (Box 312)—output for treated product.

Thus, the above said evidences the achievement of the invention's object of the implementation of the method of hydrocarbon substances' processing, along with the device for its implementation, which ensures an improvement of the efficiency of implementing the operational process of hydrocarbon substances' processing by increasing productivity, improving environmental and economic performance as well as by expanding the types of the substances to be processed.

It is to be understood that while the apparatus and method of this invention have been described and illustrated in detail, the above-described embodiments are simply illustrative of the principles of the invention and the forms that the invention can take, and not a definition of the invention. It is to be understood also that various other modifications and changes may be devised by those skilled in the art which will embody the principles of the invention and fall within the spirit and scope thereof It is not desired to limit the invention to the exact construction and operation shown and described. The spirit and scope of this invention are limited only by the spirit and scope of the following claims.

We claim:

1. The method of electro-chemical processing of hydrocarbon substances, which includes the stage of conversion of those substances in a mixture with water or electrolyte solution by means of its processing with variable electric current, characterized in that an electro-chemical processing is carried out by a two-stage treatment, comprising a primary electro-hydrodynamic processing by means of an exposure to high voltage, short-pulse electric current discharges of variable frequency, and also comprising the main electro-hydrodynamic processing, carried out in strongly whirling counterflows of the mixture, in the field with a high radial pressure gradient, by exposing the substance to an intensive cavitation, highly developed turbulence, acoustic pressure vibrations, high-frequency alternating electromagnetic field and secondary short-circuited electric currents induced in the conductive mixture, along with a simultaneous separation of the substances formed.

2. The method as claimed in claim 1, characterized in that electric discharges of primary electro-hydrodynamic processing are distributed along the length of the flow and both the circumference and the radius of axisymmetric flow.

3. The method as claimed in claim 4, characterized in that electric discharges, distributed along the radius, are formed in the mixture, which is fed into discharge area from an external or internal source.

4. The method as claimed in claim 5, characterized in that either air or hydrogen or methane-containing gas or other gas is fed into discharge area.

5. The method as claimed in claim 1, characterized in that frequency and direction of high frequency alternating electromagnetic field are varied, providing in vortex chamber a broadband resonance amplification of its own frequencies of strongly whirling external and internal flows, including radial fluctuations of turbulent moles, longitudinal low-frequency vibrations along with cavitation vibrations of the collapsed bubbles.

6. The method as claimed in claim 1, characterized in that electrolysis, heating, thermal dissociation and ionization of the flow that are induced in an electrically conductive mixture by secondary short-circuited electric currents, is carried out.

7. The method as claimed in claim 1, characterized in that a diversion of external flow is carried out along an anode channel, and diversion of internal flow is carried out along a cathode channel.

8. The method as claimed in claim 1, characterized in that electro-hydrodynamic treatment is being performed by way of complementary feeding thus processed mixture with argon from an external source.

9. The device for electro-hydrodynamic processing of hydrocarbon substances, characterized in that it contains a block for primary electro-hydrodynamic mixture processing, whereas the said block comprising of a tangential nozzle swirling device and a block of the main electro-hydrodynamic mixture processing, designed as a vortex chamber with an inside block of coaxial tubular conductors and with its cylindrical outer surface surrounded by a block of electrical windings; wherein a tangential swirling device, from one side, is connected to one or more tangential inlet fittings, connected to one or more outlet fittings of discharge chamber of primary processing block, and, from the other side, it is connected to vortex chamber of the main processing block; wherein that
vortex chamber contains two outlet fittings, one of which is placed in the plane of tangential nozzle swirling device, in alignment with vortex chamber, and the other outlet fitting is mounted at the opposite end of vortex chamber, wherein vortex chamber is made of a dielectric material.

10. The device of claim 9, wherein a block of coaxial tubular conductors is mounted at the opposite end of vortex chamber and is designed as coaxial cylindrical shells in alignment with the central axis of vortex chamber, connected the next but one by jumper straps placed in different ends of shells; wherein outer shell is connected to the current supply electrode, placed on a cylindrical wall of the output device's casing, and inner shell is connected to the current supply electrode, placed on the end wall of the output device's casing.

11. The device of claim 9, wherein a block of electrical windings is placed at the opposite to swirling device end of vortex chamber, prior to allocation block of coaxial cylindrical shells.

12. The device as claimed in claim 11, characterized in that a block of electrical windings is connected to external switching device, which generates in it a high-frequency electromagnetic field, controlled by frequency and by direction.

13. The device as claimed in claim 8, characterized in that a block of primary electro-hydrodynamic mixture processing contains an axisymmetric discharge chamber with discharge devices placed on its casing, which are connected to external switching device, generating high voltage, short-pulse electric current discharges, that are supplied to electrodes.

14. The device as claimed in claim 13, characterized in that discharge devices are placed both along the length and along the circumference of axisymmetric chamber.

15. The device as claimed in claim 13, characterized in that one or more pairs of discharge devices are placed in parallel along the radius of axisymmetric chamber.

16. The device as claimed in claim 15, characterized in that discharge devices are fed with either air or hydrogen or methane-containing gas or other gas, which is withdrawn into discharge area through openings in the side walls of electrodes towards each other.

17. The device as claimed in claim 9, characterized in that the inner casing of vortex chamber is coated with catalytic agents containing zinc, chromium, group VIII metals of the Periodic system of chemical elements and ZSM type zeolites with metal salts; that the inner surface of outlet fitting, placed at the inlet to vortex chamber, is coated with catalytic agents, containing carbides, nitrides, borides and oxides of group IV metals of the Periodic system of chemical elements and that that that very outlet fitting, placed at the inlet to vortex chamber, is connected to a cathode electrode, and the outlet fitting, mounted at the opposite end of vortex chamber, is connected to an anode electrode.

18. The device as claimed in claim 10, characterized in that inner shell contains an opening, which, from one side, is interconnected to inner volume of outlet device's casing and, from the other side,—to the inner volume of vortex chamber.

19. The device as claimed in claim 18, characterized in that the electrode, connected to inner shell, is made hollow, and it is interconnected to the inner volume of vortex chamber and to openings in the side walls of electrodes of discharge devices.

20. The device as claimed in claim 9, characterized in that the flow part of tangential nozzle swirling device is designed as a de Laval nozzle, outlet portion of which tangentially mates with ring channel, which forms the inner surface of tangential nozzle swirling device, profiled in accordance with the spiral of Archimedes.
